(19) United States
(12) Patent Application Publication
(10) Pub. No.: US 2022/0316669 A1
(43) Pub. Date: Oct. 6, 2022

(54) DOWNLIGHT STRUCTURE

(71) Applicant: Q.E (SHENZHEN) ELECTRONIC TECHNOLOGY CO., LTD., Shenzhen (CN)

(72) Inventor: Xiangbo Xiao, Shenzhen (CN)

(21) Appl. No.: 17/838,214

(22) Filed: Jun. 11, 2022

Related U.S. Application Data
(63) Continuation of application No. PCT/CN2020/121397, filed on Oct. 16, 2020.

(30) Foreign Application Priority Data
Dec. 11, 2019 (CN) 201911265838.2

(51) Int. Cl. F21S 8/02; F21V 14/02; F21V 21/04

(52) U.S. Cl. CPC F21S 8/026; F21V 14/02; F21V 21/047

(57) ABSTRACT

A downlight structure includes a light body and a light source (5). The light body includes a support (1), a movable light holder assembly (2), a base (3), and a supporting ring (4). The movable light holder assembly (2) is movably connected to a top of the support (1). The base (3) is arranged at a bottom of the support (1) after connected to the supporting ring (4). The light source (5) is arranged on the movable light holder assembly (2), and moves longitudinally or horizontally in the light with the movable light holder assembly (2). Through delicate design of the structure of the light body and the light source (5) of the downlight, the present disclosure provides a convenient solution for replacing the light source of the downlight with bare hands, and also provides a feasible solution for standardization of the downlight industry.

### CROSS REFERENCE TO RELATED APPLICATIONS

The present application is a Continuation application of PCT Application No. PCT/CN2020/121397 filed on Oct. 16, 2020, which claims the benefit of Chinese Patent Application No. 201911265838.2 filed on Dec. 11, 2019. All the above are hereby incorporated by reference in their entirety.

### TECHNICAL FIELD

The present disclosure relates to the technical field of lighting, and in particular, to a downlight structure.

### BACKGROUND

Downlights have been widely used in indoor lighting due to their simplicity, beauty, and necessity in many lighting places for a long time in the field of lighting. Due to their various special structures and the flat light-emitting surface, light-emitting diode (LED) light sources do not match the structure of a traditional downlight fixture, and even if a LED source is finally assembled with the traditional fixture, no satisfactory lighting or aesthetic effects can be achieved. As a result, there are LED downlights with integrated light source and lighting fixture on the market. The light source of such downlights cannot be replaced because of the integrated design. The downlights can only be replaced as a whole when broken, which causes waste, and the downlights must be replaced by professional electricians, which increases the replacement cost. Especially in the European and American markets where the labor cost is high, the replacement cost is even more prominent. Furthermore, it is inconvenient to replace an integrated downlight, and is easy to damage a decorative surface of the ceiling, resulting in losses. Alternatively, the LED light source is barely put in an old-fashioned downlight. Although the light source and the light can be separated, due to the uneven style, size and power of the light sources, most of the light sources cannot be used, and a few light sources that can be used cannot meet neatness and beauty requirements and achieve ideal lighting effects.

Next, the current troubles of the LED downlight industry and even the entire LED lighting industry lie in: product structures and product configurations are diverse, there is no unified industry standard, and products of different categories and brands cannot be compatible and assembled with each other, which is not conducive to standardized production and improvement of production efficiency, and also inconvenient for users.

In addition, the traditional LED integrated downlight light source cannot be placed along the depth of the inner circle of the downlight, which is not conducive to adjusting the illumination range and eliminating glare.

### SUMMARY

### Technical Problem

An objective of the present disclosure is to provide a downlight structure to solve the problem of separation of a light source and a light, and another objective of the present disclosure is to provide a downlight structure that is a feasible solution to industry standardization of downlights and LED light sources.

### Technical Solutions

A first technical solution of the present disclosure is a downlight structure, where it includes a vertical light body and a light source.

The vertical light body includes a vertical support, a movable light holder assembly, a base, and a supporting ring. The movable light holder assembly is movably connected to a top of the vertical support. The base is fixed at a bottom of the vertical support through a metal connecting piece. The supporting ring is tightly combined with an inner wall of the base through a connecting piece.

The light source is connected to the movable light holder assembly. A light-emitting portion at a bottom surface of the light source is provided with a boss. The boss of the light source is fittingly placed into an inner circle of the supporting ring to limit horizontal displacement of the light source on the supporting ring when the light source is connected to the movable light holder assembly. The light source in a static state is supported by the supporting ring and is positioned and placed.

As a preferred embodiment, the top of the vertical support may have a ring structure. At least two through holes may be evenly arranged surrounding the ring. The bottom may be provided with a threaded hole matched with the base. A plurality of clamping holes may be formed at a side of the vertical support. A compression spring may be arranged on each of the clamping holes. The vertical light body may be arranged in a ceiling.

As a preferred embodiment, the movable light holder assembly may include a top plate, a pressing ring plate, a plurality of guide posts, a light holder, and a return spring. At least two guide post positioning holes and one wire hole may be formed in the top plate. A central hole may be formed in the pressing ring plate. At least two circular holes may be evenly arranged surrounding the central hole. The guide posts may each include one end fixed at a bottom of the top plate through the guide post positioning hole and the other end passing through the through hole in the vertical support and the circular hole in the pressing ring plate from top to bottom with its tail being locked by a metal structural part. The movable light holder assembly may be movably connected to the vertical support. The return spring may be sleeved on the guide post at a specific position between the vertical support and the pressing ring plate. The light holder may be fixed at a bottom surface of the top plate by screws after passing through the central hole of the pressing ring plate and an inner circle of the ring of the support. The movable light holder assembly may move longitudinally on the vertical support. The light source may be arranged on the light holder and move longitudinally in the vertical light body with the movable light holder assembly.

As a preferred embodiment, the connecting piece between the supporting ring and the inner wall of the base may be functioned in a way selected from one of the following: snap-fit, thread spinning, and screw fixation.

As a preferred embodiment, the light holder may be selected from one of the following models: an E-type light holder, a G-type light holder, a GU-type light holder, an MR-type light holder, and a B-type light holder, and a use model of the light source may correspond to that of the light holder.

A second technical solution of the present disclosure is a downlight structure, where it includes a horizontal light body and a horizontally inserted light source.

The horizontal light body includes a horizontal support assembly, a movable light holder assembly, a base, and a supporting ring. The movable light holder assembly is movably connected to a side plate of the horizontal support assembly. The base is fixed at a bottom of a cantilever of the horizontal support assembly through a metal connecting piece. The supporting ring is tightly combined with an inner wall of the base through a connecting piece.

The horizontally inserted light source is connected to the movable light holder assembly. A light-emitting portion at a bottom surface of the horizontally inserted light source is provided with a boss. The boss of the horizontally inserted light source is fittingly placed into an inner circle of the supporting ring to limit horizontal displacement of the horizontally inserted light source on the supporting ring when the horizontally inserted light source is connected to the movable light holder assembly. The horizontally inserted light source in a static state is supported by the supporting ring and is positioned and placed.

As a preferred embodiment, the horizontal support assembly may include a horizontal support, a positioning spring component, and at least two cantilevers. The horizontal support may be in a “┐” shape. A circular hole may be formed in a center of a side plate of the horizontal support. At least two through holes may be formed surrounding the circular hole. A positioning through hole may penetrate one end of a top plate of the horizontal support away from the side plate. Tops of the cantilevers may be circumferentially fixed at a bottom of the top plate of the horizontal support with the positioning through hole as a center. A bottom of each of the cantilevers may be provided with a threaded hole matched with the base. A clamping hole may be formed at a side of each of the cantilevers. A compression spring may be arranged on the clamping hole. The compression springs on the plurality of cantilevers may cooperate to arrange the horizontal light body in a ceiling. The positioning spring component may include a positioning guide post, a positioning spring, and a pressing plate. A circular hole may be formed in a center of the pressing plate. The positioning guide post may pass through the positioning through hole of the top plate of the horizontal support and the central circular hole of the pressing plate with its both ends respectively being locked by metal structural parts. The positioning spring may be sleeved on the positioning guide post and placed between the top plate of the horizontal support and the pressing plate. The positioning spring component may be movably connected to the top plate of the horizontal support. The positioning spring component may give a downward force to the horizontally inserted light source under an action of an elastic force when the horizontally inserted light source is connected to the movable light holder assembly, such that the horizontally inserted light source may be placed on an upper side of the supporting ring, the boss of the horizontally inserted light source may be fittingly placed into the inner circle of the supporting ring, and the horizontally inserted light source in a static state may be supported by the supporting ring and may be positioned and placed.

As a preferred embodiment, the movable light holder assembly may include a top plate, a pressing ring plate, a plurality of guide posts, and a light holder. At least two guide post positioning holes and one wire hole may be formed in the top plate. A central hole may be formed in the pressing ring plate. At least two circular holes may be evenly arranged surrounding the central hole. The guide posts may each include one end fixed at a bottom of the top plate through the guide post positioning hole and the other end horizontally passing through the through hole of the side plate of the horizontal support and the circular hole in the pressing ring plate with its tail being locked by a metal structural part. The movable light holder assembly may be movably connected to the horizontal support assembly. The light holder may be fixed at a bottom surface of the top plate by screws after passing through the central hole of the pressing ring plate and the circular hole of the side plate of the horizontal support. The movable light holder assembly may move horizontally on the horizontal support. The horizontally inserted light source may be arranged on the light holder and move horizontally in the horizontal light body with the movable light holder assembly.

As a preferred embodiment, the connecting piece between the supporting ring and the inner wall of the base may be functioned in a way selected from one of the following ways: snap-fit, thread spinning, and screw fixation.

As a preferred embodiment, the light holder may be selected from one of the following models: an E-type light holder, a G-type light holder, a GU-type light holder, an MR-type light holder, and a B-type light holder, and a use model of the light source may correspond to that of the light holder.

A third technical solution of the present disclosure is a downlight structure, where it includes a surface mounted light body and a light source.

The surface mounted light body includes a cavity, a cavity top cover, a movable light holder assembly, and a supporting ring. The movable light holder assembly is movably connected to the cavity top cover. The cavity top cover is fixed at a top of the cavity through a metal connecting piece. A central hole is formed at a bottom of the cavity. The supporting ring is tightly combined with an inner wall of the central hole at the bottom of the cavity through a connecting piece.

The light source is connected to the movable light holder assembly. A light-emitting portion at a bottom surface of the light source is provided with a boss. The boss of the light source is fittingly placed into an inner circle of the supporting ring to limit horizontal displacement of the light source on the supporting ring when the light source is connected to the movable light holder assembly. The light source in a static state is supported by the supporting ring and is positioned and placed.

As a preferred embodiment, a plurality of fixing holes may be evenly formed at a top side of the cavity along a circumference. A plurality of mounting holes may be formed in the cavity top cover. A circular hole may penetrate a center of the cavity. At least two through holes may be evenly arranged surrounding the circular hole. A folding edge may be provided around the cavity top cover. Threaded holes matched with the fixing holes of the cavity may be arranged in the folding edge. The cavity top cover may be fixed at the top of the cavity.

As a preferred embodiment, the movable light holder assembly may include a top plate, a pressing ring plate, a plurality of guide posts, a light holder, and a return spring. At least two guide post positioning holes and one wire hole may be formed in the top plate. A central hole may be formed in the pressing ring plate. At least two circular holes may be evenly arranged surrounding the central hole. The guide posts may each include one end fixed at a bottom of the top plate through the guide post positioning hole and the other end passing through the through hole surrounding the circular hole of the cavity top cover and the circular hole in the pressing ring plate from top to bottom with its tail being locked by a metal structural part. The movable light holder assembly may be movably connected to the cavity top cover. The return spring may be sleeved on the guide post at a specific position between the cavity top cover and the pressing ring plate. The light holder may be fixed at a bottom surface of the top plate by screws after passing through the central hole of the pressing ring plate and the central circular hole of the cavity top cover. The movable light holder assembly may move longitudinally on the cavity top cover. The light source may be arranged on the light holder and move longitudinally in the cavity with the movable light holder assembly.

As a preferred embodiment, the connecting piece between the supporting ring and the inner wall of the central hole at the bottom of the cavity may be functioned in a way selected from one of the following: snap-fit, thread spinning, and screw fixation.

As a preferred embodiment, the light holder may be selected from one of the following models: an E-type light holder, a G-type light holder, a GU-type light holder, an MR-type light holder, and a B-type light holder, and a use model of the light source may correspond to that of the light holder.

### Beneficial Effects

(1) Through delicate design of the structure of the light body and the light source of the downlight, the present disclosure provides a convenient solution for replacing the light source of the downlight with bare hands, which is convenient for users to repair and maintain by themselves. The users can replace the light source by manually pushing up the light source, removing the supporting ring, and taking out the light source, which is very simple.

(2) By standardizing the size of the inner circle of the supporting ring and the size of the boss of the light source, a unified specification standard for downlights and LED light sources can be formulated, so as to provide a feasible solution for standardization of the downlight industry. Industry standardization is beneficial to realize large-scale production and popularization and application, thereby improving the production efficiency and market effect.

(3) The light source is connected to the movable light holder assembly, which can make the light source move longitudinally in the light body. With the supporting rings of different inner wall heights, the light source is raised along the inner wall of the downlight in depth to adjust the illumination range and eliminate glare. In addition, the height (thickness) size of the light body of the LED light source has a sufficient variation range to meet the space requirements of the light source for different power radiator sizes.

(4) The bottom edge of the supporting ring can be designed as a downlight face ring. Different styles of downlights can be obtained only by matching the same light body with different supporting rings. The light body can be produced and stored according to standard parts, which is beneficial to improve production efficiency and make appearance design more convenient.

### BRIEF DESCRIPTION OF THE DRAWINGS

FIG. 1 is a schematic structural diagram of a first embodiment of the present disclosure;

FIG. 2 is a structural explosion diagram of the first embodiment of the present disclosure;

FIG. 3 is a structural entity diagram of a second embodiment of the present disclosure;

FIG. 4 is an explosion diagram of a horizontal structure of the second embodiment of the present disclosure;

FIG. 5 is an explosion diagram of a longitudinal structure of the second embodiment of the present disclosure;

FIG. 6 is a schematic structural diagram of a third embodiment of the present disclosure; and

FIG. 7 is a structural explosion diagram of the third embodiment of the present disclosure.

### REFERENCE NUMERALS

| | | | |
|---|---|---|---|
| 1 vertical | 11 ring | 12 through hole | 13 threaded hole |
| support, | structure, | of vertical | of vertical |
| | | support, | support, |
| 14 clamping hole | 2 movable light | 21 top plate, | 211 guide post |
| of vertical | holder | | positioning |
| support, | assembly, | | hole, |
| 212 wire hole, | 22 pressing | 221 central hole, | 222 guide hole, |
| | ring plate, | | |
| 23 guide post, | 24 light holder, | 25 return spring, | 26 nut, |
| 3 base, | 4 supporting | 5 light source, | 51 boss of light |
| | ring, | | source, |
| 6 compression | 7 horizontal | 71 horizontal | 711 circular hole |
| spring, | support | support, | of horizontal |
| | assembly, | | support, |
| 712 through hole | 713 positioning | 72 positioning | 721 positioning |
| of horizontal | through hole, | spring | guide post, |
| support, | | component, | |
| 722 positioning | 723 pressing | 7231 central hole | 73 cantilever, |
| spring, | plate, | of pressing plate, | |
| 731 threaded hole | 732 clamping | 8 horizontally | 81 boss of |
| of cantilever, | hole of | inserted light | horizontally |
| | cantilever, | source, | inserted light |
| | | | source, |
| 91 cavity, | 911 fixing | 92 cavity top | 921 mounting |
| | hole, | cover, | hole, |
| 922 circular hole | 923 through | 924 folding edge, | 9241 threaded |
| of cavity, | hole of cavity, | | hole, |

### DETAILED DESCRIPTION

### Embodiment 1

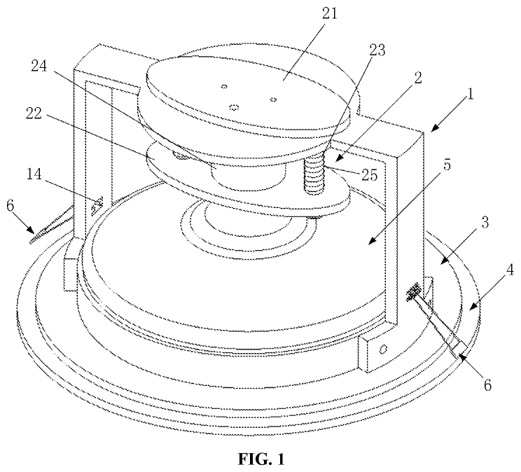

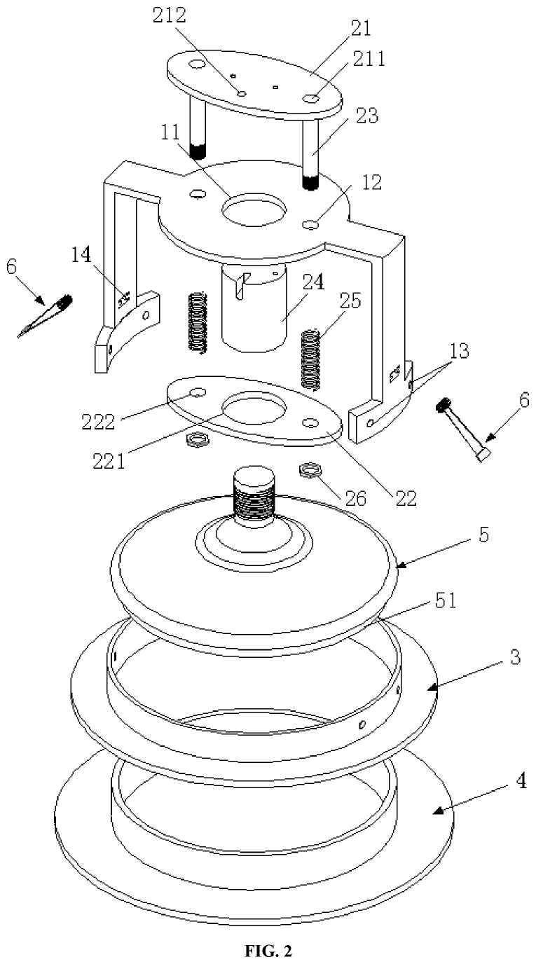

Referring to FIG. 1 and FIG. 2, a downlight structure includes a vertical light body and a light source 5. The vertical light body includes a vertical support 1, a movable light holder assembly 2, a base 3, and a supporting ring 4. The movable light holder assembly 2 is movably connected to a top of the vertical support 1. The base 3 is fixed at a bottom of the vertical support 1 with screws. The supporting ring 4 is tightly combined with an inner wall of the base 3 through a connecting piece. The light source 5 is connected to the movable light holder assembly 2. A light-emitting portion at a bottom surface of the light source 5 is provided with a boss 51. The boss of the light source 51 is fittingly placed into an inner circle of the supporting ring 4 to limit horizontal displacement of the light source 5 on the supporting ring 4 when the light source 5 is connected to the movable light holder assembly 2. The light source 5 in a static state is supported by the supporting ring 4 and is positioned and placed, and can move longitudinally in the vertical light body with the movable light holder assembly 2 by an external force.

The cross section of the vertical support 1 is a “ [symbol] ” shaped structure, and the top of the vertical support has a ring structure 11. Two through holes 12 of the vertical support are evenly arranged surrounding the ring structure 11. A bottom of the vertical support is provided with threaded holes 13 matched with the base. A clamping hole 14 of the vertical support is formed at each side of the vertical support 1. A compression spring 6 is arranged on each of the clamping holes 14 of the vertical support. The vertical light body is arranged in a ceiling.

The movable light holder assembly 2 includes a top plate 21, a pressing ring plate 22, two guide posts 23, a light holder 24, and a return spring 25. Two guide post positioning holes 211 and one wire hole 212 are formed in the top plate. A central hole 221 is formed in the pressing ring plate 22. Two guide holes 222 are evenly arranged surrounding the central hole 221. The guide posts 23 each is a double end bolt, and includes one end fixed at a bottom of the top plate 21 through the guide post positioning hole 211 and the other end passing through the through hole 12 in the vertical support 1 and the circular hole 222 in the pressing ring plate 22 from top to bottom with its tail being fixed by screwing a nut 26. The movable light holder assembly 2 is movably connected to the vertical support 1. The return spring 25 is sleeved on the guide post 23 at a specific position between the vertical support 1 and the pressing ring plate 22. The light holder 24 is fixed at a bottom surface of the top plate 21 by screws after passing through the central hole 221 of the pressing ring plate 22 and an inner circle of the ring structure 11 of the vertical support. The movable light holder assembly 2 moves longitudinally on the vertical support 1. The light source 5 is arranged on the light holder 24 and can move longitudinally in the vertical light body with the movable light holder assembly 2. The wire of the light holder 24 is extended through the wire hole 212 and communicated with an external power supply.

The connecting piece between the supporting ring 4 and the inner wall of the base 3 is functioned in a way selected from one of the following: snap-fit, thread spinning, and screw fixation.

The light holder 24 is selected from one of the following models according to the model of the light source 5 to be mounted: an E-type light holder, a G-type light holder, a GU-type light holder, an MR-type light holder, and a B-type light holder.

### Implementations of the Present Disclosure

### Embodiment 2

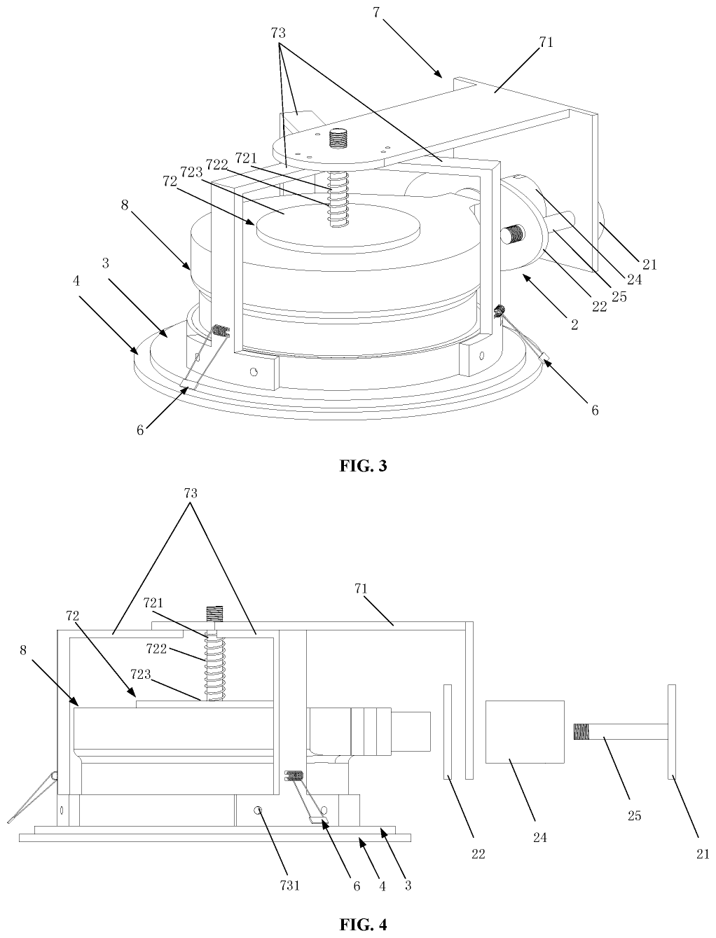

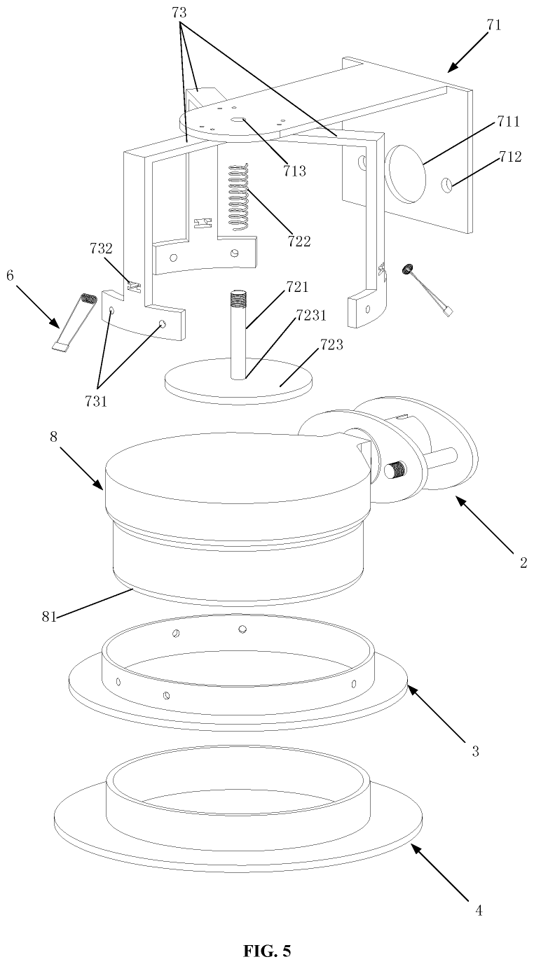

Referring to FIG. 3, FIG. 4 and FIG. 5, a downlight structure includes a horizontal light body and a horizontally inserted light source 8. The horizontal light body includes a horizontal support assembly 7, a movable light holder assembly 2, a base 3, and a supporting ring 4. The movable light holder assembly 2 is movably connected to a side plate of the horizontal support assembly 7. The base 3 is fixed at a bottom of a cantilever 73 of the horizontal support assembly 7 by riveting. The supporting ring 4 is tightly combined with an inner wall of the base 3 through a connecting piece. The horizontally inserted light source 8 is connected to the movable light holder assembly 2. A light-emitting portion at a bottom surface of the horizontally inserted light source 8 is provided with a boss 81. The boss of the horizontally inserted light source 81 is fittingly placed into an inner circle of the supporting ring 4 to limit horizontal displacement of the horizontally inserted light source 8 on the supporting ring 4 when the horizontally inserted light source 8 is connected to the movable light holder assembly 2. The horizontally inserted light source 8 in a static state is supported by the supporting ring 4 and is positioned and placed. When an external force pushes the horizontally inserted light source upward and away from the supporting ring 4, the horizontally inserted light source 8 can move horizontally in the horizontal light body along with the movable light holder assembly 2.

The horizontal support assembly 7 includes a horizontal support 71, a positioning spring component 72, and three cantilevers 73. The horizontal support 71 is in a “ [symbol] ” shape. A circular hole 711 of the horizontal support is formed in a center of a side plate of the horizontal support 71. Two through holes of the horizontal support 712 are formed surrounding the circular hole 711 of the horizontal support. A positioning through hole 713 penetrates one end of a top plate of the horizontal support 7 away from the side plate. Tops of the cantilevers 73 are circumferentially and evenly fixed at a bottom of the top plate of the horizontal support 7 with the positioning through hole 713 as a center. A bottom of each of the cantilevers 73 is provided with a threaded hole matched with the base 3. A clamping hole of the cantilever 732 is formed at a side of each of the cantilevers 73. A compression spring 6 is arranged on the clamping hole of the cantilever 732. The compression springs 6 on the plurality of cantilevers 73 cooperate to arrange the horizontal light body in a ceiling. The positioning spring component 72 includes a positioning guide post 721, a positioning spring 722, and a pressing plate 723. A central hole of the pressing plate 7231 is formed in a center of the pressing plate 723. The positioning guide post 721 is a double end bolt, and sequentially passing through the positioning through hole 713 of the top plate of the horizontal support 71 and the central hole of the pressing plate 7231 with both ends respectively locked by nuts. The positioning spring 722 is sleeved on the positioning guide post 721 and placed between the top plate of the horizontal support 71 and the pressing plate 723. The positioning spring component 72 is movably connected to the top plate of the horizontal support 71. The positioning spring component 72 gives a downward force to the horizontally inserted light source 8 under an action of an elastic force when the horizontally inserted light source 8 is connected to the movable light holder assembly 2, such that the horizontally inserted light source 8 is placed on an upper side of the supporting ring 4, the boss of the horizontally inserted light source 81 is fittingly placed into the inner circle of the supporting ring 4, and the horizontally inserted light source in a static state is supported by the supporting ring and is positioned and placed.

The movable light holder assembly 2 includes a top plate 21, a pressing ring plate 22, two guide posts 23, and a light holder 24. Two guide post positioning holes 211 and one wire hole 212 are formed in the top plate. A central hole 221 is formed in the pressing ring plate 22. Two guide holes 222 are evenly arranged surrounding the central hole 221. The guide posts 23 each is a double end bolt, and includes one end fixed at a bottom of the top plate 21 through the guide post positioning hole 211 and the other end horizontally passing through the through hole of the horizontal support 712 of the side plate of the horizontal support 71 and the circular hole 222 in the pressing ring plate 22 with its tail being locked by a nut. The movable light holder assembly 2 is movably connected to the horizontal support assembly 7. The light holder 24 is fixed at a bottom surface of the top plate 21 by screws after passing through the central hole 221 in the pressing ring plate 22 and the circular hole 711 in the horizontal support. The movable light holder assembly 2 moves horizontally on the horizontal support 71. The horizontally inserted light source 8 is arranged on the light holder 24 and can move horizontally in the horizontal light body with the movable light holder assembly 2. The wire of the light holder 24 is extended through the wire hole 212 and communicated with an external power supply.

The connecting piece between the supporting ring 4 and the inner wall of the base 3 is functioned in a way selected from one of the following: snap-fit, thread spinning, and screw fixation.

The light holder 24 is selected from one of the following models according to the model of the horizontally inserted light source 8 to be mounted: an E-type light holder, a G-type light holder, a GU-type light holder, an MR-type light holder, and a B-type light holder.

### Embodiment 3

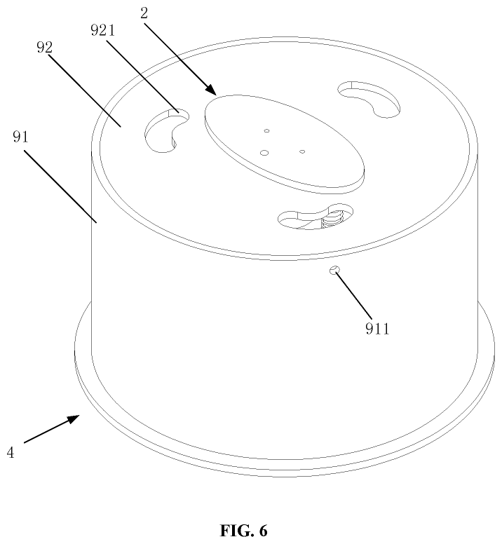

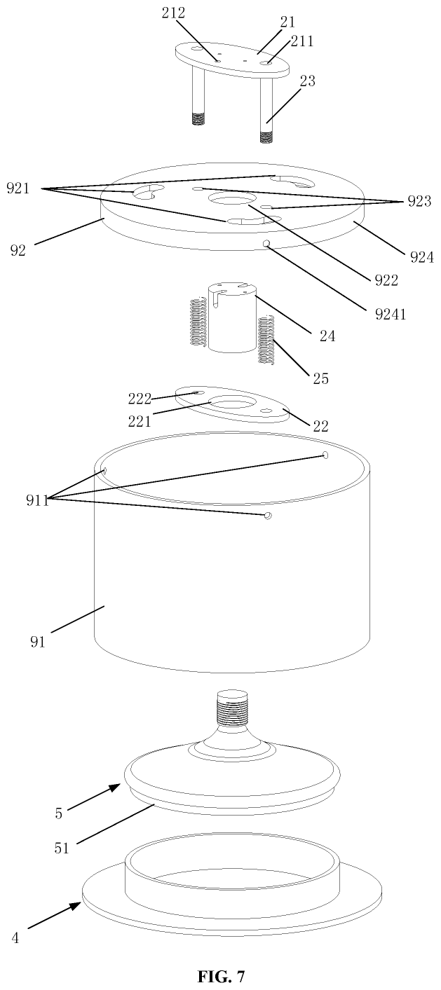

Referring to FIG. 6 and FIG. 7, a downlight structure includes a surface mounted light body and a light source. The surface mounted light body includes a cavity 91, a cavity top cover 92, a movable light holder assembly 2, and a supporting ring 4. The movable light holder assembly 2 is movably connected to the cavity top cover 92. The cavity top cover 92 is fixed at a top of the cavity 91 with screws. A central hole is formed at a bottom of the cavity 91. The supporting ring 4 is tightly combined with an inner wall of the central hole at the bottom of the cavity 91 through a connecting piece. The light source 5 is connected to the movable light holder assembly 2. A light-emitting portion at a bottom surface of the light source 5 is provided with a boss 51. The boss of the light source 51 is fittingly placed into an inner circle of the supporting ring 4 to limit horizontal displacement of the light source 5 on the supporting ring 4 when the light source 5 is connected to the movable light holder assembly 2. The light source 5 in a static state is supported by the supporting ring 4 and is positioned and placed, and can move longitudinally in the cavity 91 with the movable light holder assembly 2 by an external force.

A plurality of fixing holes 911 is evenly formed at a top side of the cavity 91 along a circumference. A plurality of mounting holes 921 is formed in the cavity top cover 92. A circular hole of the cavity 922 penetrates a center of the cavity. At least two through holes of the cavity 923 are evenly arranged surrounding the circular hole of the cavity 922. An outer ring of the cavity top cover 92 is bent downward to form a folding edge 924. Threaded holes 9241 matched with the fixing holes of the cavity 911 are arranged in the folding edge 924. The cavity top cover 92 is fixed at the top of the cavity 91. The surface mounted light body as a whole is mounted and fixed in a ceiling through the mounting holes 921 of the cavity top cover 92 with screws.

The movable light holder assembly 2 includes a top plate 21, a pressing ring plate 22, two guide posts 23, a light holder 24, and a return spring 25. Two guide post positioning holes 211 and one wire hole 212 are formed in the top plate 21. A central hole 221 is formed in the pressing ring plate 22. Two guide holes 222 are evenly arranged surrounding the central hole 221. The guide posts 23 each is a double end bolt, and includes one end fixed at a bottom of the top plate 21 through the guide post positioning hole 211 and the other end passing through the through hole of the cavity 923 surrounding the cavity circular hole 922 in the cavity top cover 92 and the circular hole 222 in the pressing ring plate 22 from top to bottom, and a tail end locked by a nut. The movable light holder assembly 2 is movably connected to the cavity top cover 92. The return spring 25 is sleeved on the guide post 23 at a specific position between the cavity top cover 92 and the pressing ring plate 22. The light holder 24 is fixed at a bottom surface of the top plate 21 by screws after passing through the central hole 221 of the pressing ring plate and the circular hole of the cavity 922 formed in the cavity top cover 92. The movable light holder assembly 2 moves longitudinally in the cavity 91. The light source 5 is arranged on the light holder 24 and can move longitudinally in the cavity 91 with the movable light holder assembly 2. The wire of the light holder 24 is connected from the wire hole 212 and communicated with an external power supply.

As a preferred embodiment: the supporting ring 4 can be designed to be in a face ring shape with a wide bottom edge and be used as a downlight face ring to replace the bottom edge of the base 3, or designed to be in an inner ring shape with a narrow bottom edge to hide into the inner wall of the base 3. Alternatively, the inner wall height of the supporting ring 4 can be increased to raise the light source, so as to adjust the illumination range and eliminate glare.

As a preferred embodiment: the movable structure of the guide post in the movable light holder assembly 2 can be replaced by a chute structure to accomplish the same structural function.

### INDUSTRIAL APPLICABILITY

The above is merely preferred embodiments of the present disclosure, and all equivalent changes and modifications made according to the scope of the claims of the present disclosure shall fall within the scope covered in the claims of the present disclosure.

1. A downlight structure, comprising a vertical light body and a light source, wherein
the vertical light body comprises a vertical support, a movable light holder assembly, a base, and a supporting ring, the movable light holder assembly is movably connected to a top of the vertical support, the base is fixed at a bottom of the vertical support through a metal connecting piece, and the supporting ring is combined with an inner wall of the base through a connecting piece; and
a light holder is provided at a bottom of the movable lamp holder assembly and the light source is arranged on the light holder, a light-emitting portion at a bottom surface of the light source is provided with a boss having an external diameter corresponding to a diameter of an inner circle of the supporting ring; the boss of the light source is fittingly placed into the inner circle of the supporting ring to limit horizontal displacement of the light source on the supporting ring when the light source is connected to the movable light holder assembly, and the light source in a static state is supported by the supporting ring and is positioned and placed.

2. The downlight structure according to claim 1, wherein the top of the vertical support has a ring structure, at least two through holes are evenly arranged surrounding the ring, the bottom is provided with a threaded hole matched with the base, a plurality of clamping holes is formed at a side of the vertical support, a compression spring is arranged on each of the clamping holes, and the vertical light body is arranged in a ceiling.

3. The downlight structure according to claim 1, wherein the movable light holder assembly comprises a top plate, a pressing ring plate, a plurality of guide posts, the light holder, and a return spring, at least two guide post positioning holes and one wire hole are formed in the top plate, a central hole is formed in the pressing ring plate, at least two circular holes are evenly arranged surrounding the central hole, the guide posts each comprises one end fixed at a bottom of the top plate through the guide post positioning hole and the other end passing through the through hole in the vertical support and the circular hole in the pressing ring plate from top to bottom with its tail being locked by a metal structural part, the movable light holder assembly is movably connected to the vertical support, the return spring is sleeved on the guide post at a specific position between the vertical support and the pressing ring plate, the light holder is fixed at a bottom surface of the top plate by screws after passing through the central hole of the pressing ring plate and an inner circle of the ring of the support, the movable light holder assembly moves longitudinally on the vertical support, and the light source is arranged on the light holder and moves longitudinally in the vertical light body with the movable light holder assembly.

4. The downlight structure according to claim 2, wherein the movable light holder assembly comprises a top plate, a pressing ring plate, a plurality of guide posts, the light holder, and a return spring, at least two guide post positioning holes and one wire hole are formed in the top plate, a central hole is formed in the pressing ring plate, at least two circular holes are evenly arranged surrounding the central hole, the guide posts each comprises one end fixed at a bottom of the top plate through the guide post positioning hole and the other end passing through the through hole in the vertical support and the circular hole in the pressing ring plate from top to bottom with its tail being locked by a metal structural part, the movable light holder assembly is movably connected to the vertical support, the return spring is sleeved on the guide post at a specific position between the vertical support and the pressing ring plate, the light holder is fixed at a bottom surface of the top plate by screws after passing through the central hole of the pressing ring plate and an inner circle of the ring of the support, the movable light holder assembly moves longitudinally on the vertical support, and the light source is arranged on the light holder and moves longitudinally in the vertical light body with the movable light holder assembly.

5. The downlight structure according to claim 1, wherein the connecting piece between the supporting ring and the inner wall of the base is functioned in a way selected from one of the following: snap-fit, thread spinning, and screw fixation.

6. The downlight structure according to claim 1, wherein the light holder is selected from one of the following models: an E-type light holder, a G-type light holder, a GU-type light holder, an MR-type light holder, and a B-type light holder, and a use model of the light source corresponds to that of the light holder.

7. A downlight structure, comprising a horizontal light body and a horizontally inserted light source, wherein
the horizontal light body comprises a horizontal support assembly, a movable light holder assembly, a base, and a supporting ring, the movable light holder assembly is movably connected to a side plate of the horizontal support assembly, the base is fixed at a bottom of a cantilever of the horizontal support assembly through a metal connecting piece, and the supporting ring is combined with an inner wall of the base through a connecting piece; and
the horizontally inserted light source is connected to the movable light holder assembly, a light-emitting portion at a bottom surface of the horizontally inserted light source is provided with a boss having an external diameter corresponding to a diameter of an inner circle of the supporting ring; the boss of the horizontally inserted light source is fittingly placed into the inner circle of the supporting ring to limit horizontal displacement of the horizontally inserted light source on the supporting ring when the horizontally inserted light source is connected to the movable light holder assembly, and the horizontally inserted light source in a static state is supported by the supporting ring and is positioned and placed.

8. The downlight structure according to claim 7, wherein the horizontal support assembly comprises a horizontal support, a positioning spring component, and at least two cantilevers, the horizontal support is in a “┐” shape, a circular hole is formed in a center of a side plate of the horizontal support, at least two through holes are formed surrounding the circular hole, a positioning through hole penetrates one end of a top plate of the horizontal support away from the side plate, tops of the cantilevers are circumferentially fixed at a bottom of the top plate of the horizontal support with the positioning through hole as a center, a bottom of each of the cantilevers is provided with a threaded hole matched with the base, a clamping hole is formed at a side of each of the cantilevers, a compression spring is arranged on the clamping hole, the compression springs on the plurality of cantilevers cooperate to arrange the horizontal light body in a ceiling, the positioning spring component comprises a positioning guide post, a positioning spring, and a pressing plate, a circular hole is formed in a center of the pressing plate, the positioning guide post passes through the positioning through hole of the top plate of the horizontal support and the central circular hole of the pressing plate with its both ends respectively being locked by metal structural parts, the positioning spring is sleeved on the positioning guide post and placed between the top plate of the horizontal support and the pressing plate, the positioning spring component is movably connected to the top plate of the horizontal support, and the positioning spring component gives a downward force to the horizontally inserted light source under an action of an elastic force when the horizontally inserted light source is connected to the movable light holder assembly, such that the horizontally inserted light source is placed on an upper side of the supporting ring, the boss of the horizontally inserted light source is fittingly placed into the inner circle of the supporting ring, and the horizontally inserted light source in a static state is supported by the supporting ring and is positioned and placed.

9. The downlight structure according to claim 7, wherein the movable light holder assembly comprises a top plate, a pressing ring plate, a plurality of guide posts, and a light holder, at least two guide post positioning holes and one wire hole are formed in the top plate, a central hole is formed in the pressing ring plate, at least two circular holes are evenly arranged surrounding the central hole, the guide posts each comprises one end fixed at a bottom of the top plate through the guide post positioning hole and the other end horizontally passing through the through hole of the side plate of the horizontal support and the circular hole in the pressing ring plate with its tail being locked by a metal structural part, the movable light holder assembly is movably connected to the horizontal support assembly, the light holder is fixed at a bottom surface of the top plate by screws after passing through the central hole of the pressing ring plate and the circular hole of the side plate of the horizontal support, the movable light holder assembly moves horizontally on the horizontal support, and the horizontally inserted light source is arranged on the light holder and moves horizontally in the horizontal light body with the movable light holder assembly.

10. The downlight structure according to claim 8, wherein the movable light holder assembly comprises a top plate, a pressing ring plate, a plurality of guide posts, and a light holder, at least two guide post positioning holes and one wire hole are formed in the top plate, a central hole is formed in the pressing ring plate, at least two circular holes are evenly arranged surrounding the central hole, the guide posts each comprises one end fixed at a bottom of the top plate through the guide post positioning hole and the other end horizontally passing through the through hole of the side plate of the horizontal support and the circular hole in the pressing ring plate with its tail being locked by a metal structural part, the movable light holder assembly is movably connected to the horizontal support assembly, the light holder is fixed at a bottom surface of the top plate by screws after passing through the central hole of the pressing ring plate and the circular hole of the side plate of the horizontal support, the movable light holder assembly moves horizontally on the horizontal support, and the horizontally inserted light source is arranged on the light holder and moves horizontally in the horizontal light body with the movable light holder assembly.

11. The downlight structure according to claim 7, wherein the connecting piece between the supporting ring and the inner wall of the base is functioned in a way selected from one of the following ways: snap-fit, thread spinning, and screw fixation.

12. The downlight structure according to claim 7, wherein the light holder is selected from one of the following models: an E-type light holder, a G-type light holder, a GU-type light holder, an MR-type light holder, and a B-type light holder, and a use model of the light source corresponds to that of the light holder.

13. A downlight structure, comprising a surface mounted light body and a light source, wherein
the surface mounted light body comprises a cavity, a cavity top cover, a movable light holder assembly, and a supporting ring, the movable light holder assembly is movably connected to the cavity top cover, the cavity top cover is fixed at a top of the cavity through a metal connecting piece, a central hole is formed at a bottom of the cavity, and the supporting ring is combined with an inner wall of the central hole at the bottom of the cavity through a connecting piece; and
a light holder is provided at a bottom of the movable light holder assembly and the light source is arranged on the light holder; a light-emitting portion at a bottom surface of the light source is provided with a boss having an external diameter corresponding to a diameter of an inner circle of the supporting ring, the boss of the light source is fittingly placed into an inner circle of the supporting ring to limit horizontal displacement of the light source on the supporting ring when the light source is connected to the movable light holder assembly, and the light source in a static state is supported by the supporting ring and is positioned and placed.

14. The downlight structure according to claim 13, wherein a plurality of fixing holes is evenly formed at a top side of the cavity along a circumference, a plurality of mounting holes is formed in the cavity top cover, a circular hole penetrates a center of the cavity, at least two through holes are evenly arranged surrounding the circular hole, a folding edge is provided around the cavity top cover, threaded holes matched with the fixing holes of the cavity are arranged in the folding edge, and the cavity top cover is fixed at the top of the cavity.

15. The downlight structure according to claim 13, wherein the movable light holder assembly comprises a top plate, a pressing ring plate, a plurality of guide posts, the light holder, and a return spring, at least two guide post positioning holes and one wire hole are formed in the top plate, a central hole is formed in the pressing ring plate, at least two circular holes are evenly arranged surrounding the central hole, the guide posts each comprises one end fixed at a bottom of the top plate through the guide post positioning hole and the other end passing through the through hole surrounding the circular hole of the cavity top cover and the circular hole in the pressing ring plate from top to bottom with its tail being locked by a metal structural part, the movable light holder assembly is movably connected to the cavity top cover, the return spring is sleeved on the guide post at a specific position between the cavity top cover and the pressing ring plate, the light holder is fixed at a bottom surface of the top plate by screws after passing through the central hole of the pressing ring plate and the central circular hole of the cavity top cover, the movable light holder assembly moves longitudinally on the cavity top cover, and the light source is arranged on the light holder and moves longitudinally in the cavity with the movable light holder assembly.

16. The downlight structure according to claim 14, wherein the movable light holder assembly comprises a top plate, a pressing ring plate, a plurality of guide posts, a light holder, and a return spring, at least two guide post positioning holes and one wire hole are formed in the top plate, a central hole is formed in the pressing ring plate, at least two circular holes are evenly arranged surrounding the central hole, the guide posts each comprises one end fixed at a bottom of the top plate through the guide post positioning hole and the other end passing through the through hole surrounding the circular hole of the cavity top cover and the circular hole in the pressing ring plate from top to bottom with its tail being locked by a metal structural part, the movable light holder assembly is movably connected to the cavity top cover, the return spring is sleeved on the guide post at a specific position between the cavity top cover and the pressing ring plate, the light holder is fixed at a bottom surface of the top plate by screws after passing through the central hole of the pressing ring plate and the central circular hole of the cavity top cover, the movable light holder assembly moves longitudinally on the cavity top cover, and the light source is arranged on the light holder and moves longitudinally in the cavity with the movable light holder assembly.

17. The downlight structure according to claim 13, wherein the connecting piece between the supporting ring and the inner wall of the central hole at the bottom of the cavity is functioned in a way selected from one of the following: snap-fit, thread spinning, and screw fixation.

18. The downlight structure according to claim 13, wherein the light holder is selected from one of the following models: an E-type light holder, a G-type light holder, a GU-type light holder, an MR-type light holder, and a B-type light holder, and a use model of the light source corresponds to that of the light holder.
